(19) United States
(12) Patent Application Publication
(10) Pub. No.: US 2017/0359376 A1
(43) Pub. Date: Dec. 14, 2017

(54) AUTOMATED THREAT VALIDATION FOR IMPROVED INCIDENT RESPONSE

(71) Applicant: Cymmetria, Inc., Palo Alto, CA (US)

(72) Inventors: Gadi EVRON, Eli (IL); Dean Sysman, Haifa (IL); Imri Goldberg, Kfar-Netter (IL); Shmuel Ur, Shorashim (IL)

(21) Appl. No.: 15/623,054

(22) Filed: Jun. 14, 2017

Related U.S. Application Data
(60) Provisional application No. 62/349,735, filed on Jun. 14, 2016.

(51) Int. Cl. H04L 29/06

(52) U.S. Cl. CPC H04L 63/1491; H04L 63/145

(57) ABSTRACT

A method for deploying threat specific deception campaigns for updating a score given to a malicious activity threat by performing an analysis of processes executed by computing nodes of a monitored computer network. When an analysis outcome is indicative of a malicious activity threat to the monitored computer network from process(es) executed on one or more of the computing node(s): setting a score to the malicious activity threat according to potential damage characteristic(s) of the malicious activity threat when the score is above a first threshold launch a threat specific deception campaign by using at least one deception application executed by the computing node(s) for gathering additional data and updating the score according to an analysis of the additional data, and when the score/updated score is above a second threshold generate instructions for alerting an operator and/or reacting to the malicious activity on the at computing node(s).

### RELATED APPLICATIONS

This application claims the benefit of priority under 35 USC §119(e) of U.S. Provisional Patent Application No. 62/349,735, filed on Jun. 14, 2016.

This application is also related to PCT Patent Application No. PCT/IB2016/054306 titled “Decoy and Deceptive Data Object Technology” filed Jul. 20, 2016 and PCT Patent Application No. PCT/IB2017/052439 titled “Supply Chain Cyber-Deception”, the contents of which are incorporated herein by reference in their entirety.

### FIELD AND BACKGROUND OF THE INVENTION

The present invention, in some embodiments thereof, relates to responding to potential unauthorized operations in a protected device and/or network, and, more specifically, but not exclusively, to responding to potential unauthorized operations in a protected device and/or network based on an estimated risk level.

Organizations of all sizes and types face the threat of being attacked by advanced attackers who may be characterized as having substantial resources of time and tools, and are therefore able to carry out complicated and technologically advanced operations against targets to achieve specific goals, for example, retrieve sensitive data, damage infrastructure and/or the like.

Generally, advanced attackers operate in a staged manner, first collecting intelligence about the target organizations, networks, services and/or systems, initiate an initial penetration of the target, perform lateral movement and escalation within the target network and/or services, take actions on detected objectives and leave the target while covering the tracks. Each of the staged approach steps involves tactical iterations through what is known in the art as observe, orient, decide, act (OODA) loop. This tactic may present itself as most useful for the attackers who may face an unknown environment and therefore begin by observing their surroundings, orienting themselves, then deciding on a course of action and carrying it out.

### SUMMARY OF THE INVENTION

According to some embodiments of the present invention, there is provided a method for deploying threat specific deception campaigns for updating a score given to a malicious activity threat that comprises performing an analysis of a plurality of processes executed by a plurality of computing nodes of a monitored computer network and when an outcome of the analysis is indicative of a malicious activity threat to the monitored computer network from at least one process of the plurality of processes which is executed on at least one computing node of the plurality of computing nodes: setting a score to the malicious activity threat according to at least one potential damage characteristic of the malicious activity threat, when the score is above a first threshold launch a threat specific deception campaign by using at least one deception application executed by the at least one computing node for gathering additional data and updating the score according to an analysis of the additional data, and when the score or the updated score is above a second threshold generate instructions for at least one of alerting an operator and reacting to the malicious activity threat by performing at least one defensive processing action.

Optionally, the at least one potential damage characteristic comprises a network location of the at least one computing node in the monitored computer network.

Optionally, the at least one potential damage characteristic comprises a location from which the at least one computing node is being accessed when the at least one process in performed.

Optionally, the at least one potential damage characteristic comprises an estimated level of certainty of an actualization of the malicious activity threat.

Optionally, the threat specific deception campaign is held by: selecting a plurality of deception data objects according to a malicious activity threat; deploying the plurality of deception data objects in the at least one computing node; detecting usage of information contained in at least one of the plurality of deception data objects; and wherein the additional data is indicative of the usage of information.

Optionally, the at least one deception application is selected according to at least one computing node characteristic of the at least one computing node.

Optionally, the at least one deception application is selected according an analysis of a log comprising historical execution activity of a plurality of applications on the at least one computing node.

Optionally, the at least one deception application is selected according an analysis of resource access action held by the at least one computing node.

Optionally, the at least one deception application is selected according an analysis of a log documenting communication between the at least one computing node and at least one additional computing node from the plurality of computing nodes; wherein the threat specific deception campaign is held by using at least one additional deception application executed by the at least one additional computing node for gathering further additional data and updating the score according to an analysis of the further additional data.

Optionally, the threat specific deception campaign is held by identifying a type of a common use in the at least one computing node by at least one user and deploying at least one deception data object according to the common use.

More optionally, the type of a common use is selected from a group consisting of: software development usage, word processing usage, and a network storage usage.

Optionally, the threat specific deception campaign is held by deploying a decoy cookie emulating an access to a resource historically accessed by the at least one computing node and detecting an access to the decoy cookie; wherein the additional data is indicative of the access.

Optionally, the threat specific deception campaign is held by deploying a decoy file similar to a file historically accessed by the at least one computing node and detecting an access to the decoy file; wherein the additional data is indicative of the access.

Optionally, the setting comprises setting a plurality of sub scores defining a certainty value for the malicious activity threat to occur and a severity of damage from the malicious activity threat when occurred; wherein the first threshold comprises a certainty sub threshold and a severity sub threshold; the score is above the first threshold when the certainty value is above the certainty sub threshold and the severity value is above the severity sub threshold.

According to some embodiments of the present invention, there is provided a system deploying threat specific deception campaigns for updating a score given to a malicious activity threat that comprises at least one processor adapted to execute a code stored in a program store for performing an analysis of a plurality of processes executed by a plurality of computing nodes of a monitored computer network and when an outcome of the analysis is indicative of a malicious activity threat to the monitored computer network from at least one process of the plurality of processes which is executed on at least one computing node of the plurality of computing nodes: setting a score to the malicious activity threat according to at least one potential damage characteristic of the malicious activity threat, when the score is above a first threshold launch a threat specific deception campaign by using at least one deception application executed by the at least one computing node for gathering additional data and updating the score according to an analysis of the additional data, and when the score or the updated score is above a second threshold generate instructions for at least one of alerting an operator and reacting to the malicious activity threat by performing at least one defensive processing action.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process for creating and maintaining threat specific deceptions in order to reduce false positive detection of potential unauthorized operations in a monitored computer network, according to some embodiments of the present invention; and

FIG. 2 is an exemplary embodiment of a system and a monitored computer network for creating and deploying threat specific deception campaigns in order to reduce false positive detection in the monitored computer network, according to some embodiments of the present invention.

### DESCRIPTION OF SPECIFIC EMBODIMENTS OF THE INVENTION

The present invention, in some embodiments thereof, relates to responding to potential unauthorized operations in a protected device and/or network, and, more specifically, but not exclusively, to responding to potential unauthorized operations in a protected device and/or network based on an estimated risk level.

Preventive activities based on the results of risk assessments can lower the number of malicious activities, but not all malicious activities can be prevented. As used herein a malicious activity is any activity specifically intended to cause harm to an organization or its computing resources. The malicious activity is optionally an outcome of an execution of malicious software, commonly known as malware, namely any software that is intended use security vulnerabilities in a computing node or a monitored computer network. Malware can be in the form of worms, viruses, Trojans, spyware, adware and rootkits, etc., which steal protected data, delete documents or add software not approved by a user. The malicious activity is optionally an outcome of an execution of a malicious person using a network to connect to computing resources of a monitored computer network.

A response capability to malicious activities is therefore necessary for rapidly minimizing loss and destruction and/or mitigating weaknesses that were exploited by the malicious activities and restoring information technology (IT) services. Typically, a security system receives alerts, logs and/or feeds and identifies a huge number of potential threats and assigns each a probability (or use a rule engine). When a threat has high probability, above a threshold, (or a rule is fired) the threat is going to be reported, for example, to an L1 analyst and manually investigated. Typically, there are millions of alerts who do not reach the threshold or thresholds and therefore are not reported to the analyst. For example, some suspicious behavior on an endpoint which is indicative of a threat but not conclusive enough, by itself, or in connection to other alerts, to pass the threshold and therefore is not reported to the analyst.

Normally logs need to be analyzed to fire an alert. Prioritizing the analysis of log entries to decide what to move to manual verification can be challenging. Although some log sources assign their own priorities to each entry, these priorities often use inconsistent scales or ratings (e.g., high/medium/low, 1 to 5, 1 to 10), which makes it challenging to compare priority values. Also, the criteria used by different products to prioritize entries are likely to be based on different sets of requirements, some or all of which might be inconsistent with the organization's requirements.

The probability of the threat assigned is generally a multiple functions; two such parameters often used threat likelihood and perceived severity. In other cases, it could be a rule fired which takes anything into account like priority, analyst availability or anything else. For example, assume that in some user account we discovered possible evidence that someone else is using the account, the evidence could be weak such as unusual hour, medium such as unknown device or strong, login from a country that the user is not currently in. None of those is provide a certainty that there is an unauthorized use of the account. The user may be such that when his account is compromised the threat is high or low. Those factors are combined and a combined probability is assessed. In a typical system if the threat is above a threshold, an analyzer or a SOC engineer will be notified of the threat, given a log of all the information, and take appropriate actions.

The lower the threat threshold is set, the harder it is for an attacker as more suspicious activities are investigated. On the other hand, many false positives will be created, and a lot of analysis resources (time, money) will be spent on events which are not a security threat causing alert fatigue. The goal is to reduce the false positives while not sacrificing security or for the same cost get more security.

One way to reduce false positives is to deploy deception elements such as decoys, honeypots, honey tokens and breadcrumbs sometimes in combination in deception campaigns. Those techniques are used to expose attackers and to discover them with as high probability as possible, distinguishing between them and legitimate users of the system.

For example, a honeypot machine may be created whose login information is not available to legitimate users.

Any login to such honeypot machine is a very strong indication of malicious activity.

However, even with honeypot and deception campaign deployed, the basic situation described above in which we need to decide if to show information found to the analyst, and the tradeoff between security and manual work still exist.

Another way to achieve better performance is to integrate with cyber defense services that have access to additional information outside the organization. The threats detected may be sent to others to analyze but the tradeoff between security and manual work still exist still exist.

The above described processes are based on collect information; automatically analyze the information; and finding threats (e.g. millions). This allows analyzing each threat according to one or more criterions and verifying whether the score of the threat passes a threshold. When the threshold is passed, a human analyst is informed and in some cases some automatic actions are taken, for instance closing an account, writing information to a log and/or the like. In this binary scheme the system either informs the analyst or not. Some embodiments of the application described herein suggest replacing the binary threshold scheme with a threat specific approach that has three possible responses. The decision on which response to take may be based on the various criterions such as the above criterions, urgency to handle the specific threat and suitable a threat specific deception campaign which may be selected and/or generated based on characteristics of the specific threat and/or the computing nodes through which the specific threat imposes threat to the monitored network. The responses are not necessarily distinct. Urgency score is set, given information on the threat, how long before the threat fulfils and to provide an attacker with his goals. This depends on parameters such as evidence(s) and network location of processes associated with the threat and/or a location from which the computing node is accessed.

For example, the embodiments describe the process of collecting information, such as information about the execution of processes on the computing nodes of a monitored computer network, automatically analyzing the collected information, and identifying threats, for instance based on an analysis of processes using deep learning classification modules (e.g. trained neural networks), a rule based software module for classifying processes, expert system units for classifying processes or any other automated processes.

For brevity, a process means one or more computing node events, one or more threads executed on a computing node and/or one or more processes. The events and/or processes may be monitored during a period of more than few hours, for example days, weeks, months, and/or years, optionally in the kernel and/or operating system (OS) level. Optionally, events are channeled from the application program interfaces (APIs) of the operating system (OS) of a computing node, for example by utilizing API calls and/or API aggregators. Optionally or alternatively, a malicious threat monitoring module which is installed in one or more of the computing nodes of monitored network channels events using a kernel driver, optionally, a shadow kernel driver. The kernel driver initiates before the OS is loaded and collects events in the kernel level. Such a kernel driver may have a higher priority and more authorizations than a process executed by the OS.

For each threat according to one or more criterions, including urgency and optionally, the availability or the possibility to generate threat specific campaign the response may be:

When a score of an identified threat is above a first threshold deploying a threat specific deception campaign, analyzing the result of deploying the threat specific deception campaign, for instance gathering data indicative of access to deception objects such as decoy files and/or values and go back to calculate a score and evaluate whether the score passes a threshold or not after a relevant amount of time for re-assessment. Optionally, the score takes into account urgency and the availability of threat specific campaign the response.

When the score of the identified threat is above a second threshold instructions to alert an operator and/or launch defensive processing actions are generated and sent. This allows the operator, for example an analyst to manually deploy threat specific deceptions campaigns. In such an embodiment, threat specific deceptions campaigns, for example as described below, are presented to the user using a graphical user interface (GUI). The optional defensive processing actions may be closing an account, writing information to a log, and/or the like.

In the above described scheme, instead of binary response three possible reactions to a score given to a threat are available, namely ignoring the score, reacting to the score by generating a threat specific campaign, and triggering an operator notification and/or optional defensive processing actions. The threat specific campaign may be dynamically adapted according to the score. Additionally or alternatively, the optional defensive processing actions may be based on the score. For example, assume there are two threats with the same threshold.

Optionally, the score comprises a plurality of sub scores, such as certainty sub score, urgency sub score, and potential damage sub score. In such an embodiment, different optional defensive processing actions and/or different threat specific campaigns may be selected for different sub scores. For example, when a threat has high certainty sub score but low severity sub score sand urgency sub score a deception campaign is selected and deployed. The severity sub score is the amount of damage that may be caused by the attack, at a location it was found, given what we know about it, can cause. When a threat does not have a deception campaign an operator may be automatically informed. When the urgency sub score is high, an operator may be automatically informed as no time is left for collecting information for upgrading certainty of the calculated score. As used herein a certainty score is indicative of how likely is evidence pointing to a real malicious activity.

Optionally, each threat is time stamped so as to allow managing an aging procedure. In such embodiment, urgency sub score may be increased over time. This means that a different set of threats will be shown to an operator with a result of having less false positives. Optionally, a set of deception campaigns are made available for deployment with a push of a button, for instance a set of threat specific deception campaigns which are adapted according to characteristics of the specific threat and/or the computing nodes through which the specific threat imposes threat to the monitored network. The campaigns allow assessing more accurately the score or any of the sub scores and/or collect more information on the threat.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

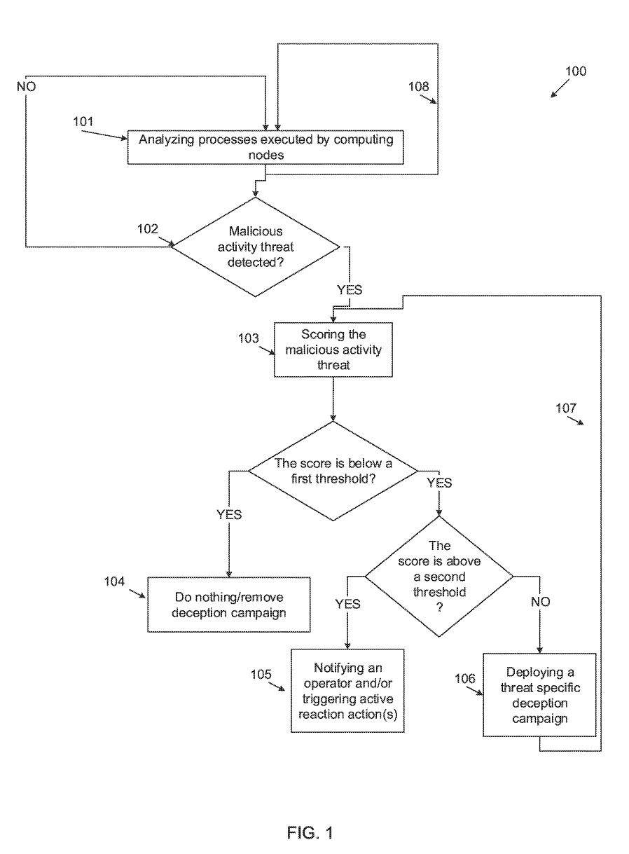

Reference is now made to FIG. 1, which is a flowchart of an exemplary process for creating and maintaining threat specific deceptions in order to reduce false positive detection of potential unauthorized operations in a monitored computer network, according to some embodiments of the present invention. A process 100 is executed to launch one or more threat specific deception campaigns when a suspected malicious activity threat of one or more processes executed by or held on computing nodes of a monitored network is detected and scored with a score set according to a certain threshold. The deception campaign is optionally as described in U.S. patent application Ser. No. 15/414,850 which is incorporated herein by reference.

As further detailed below, a threat specific deception campaign is adapted to a threat and/or to one or more parameters of computing nodes in which related malicious activity is detected.

The threat specific deception campaigns may be based on one or more deception application(s) and/or deception objects such as file, registry values, communication records (e.g. cookies, links, and electronic mails and/or the like). The deception application(s) are launched on one or more computing nodes such as network resources and endpoints that may be physical endpoints and/or virtual endpoints. The deception data objects are deployed within the real processing environment of the monitored computer network to attract potential attacker(s) to use the deception data objects. The deception data objects are optionally of the same type(s) as valid data objects used to interact with the real OSs and/or applications in the real processing environment such that the deception environment efficiently emulates and/or impersonates as the real processing environment and/or a part thereof. When used, instead of interacting with the real operating systems and/or application, the deception data objects may interact with a control component to indicate on a malicious activity.

As the deception objects are transparent or unnecessary to the activity of legitimate users, applications, processes and/or the like of the monitored computer network, access or usage of deception objects are considered as unauthorized operation(s) that in turn may be indicative of a potential attacker. The deception data objects may be updated constantly and dynamically to avoid stagnancy and mimic a real and dynamic environment with the deception data objects appearing as valid data objects such that the potential attacker believes the emulated deception environment is a real one, for example as described in U.S. patent application Ser. No. 15/414,850 which is incorporated herein by reference.

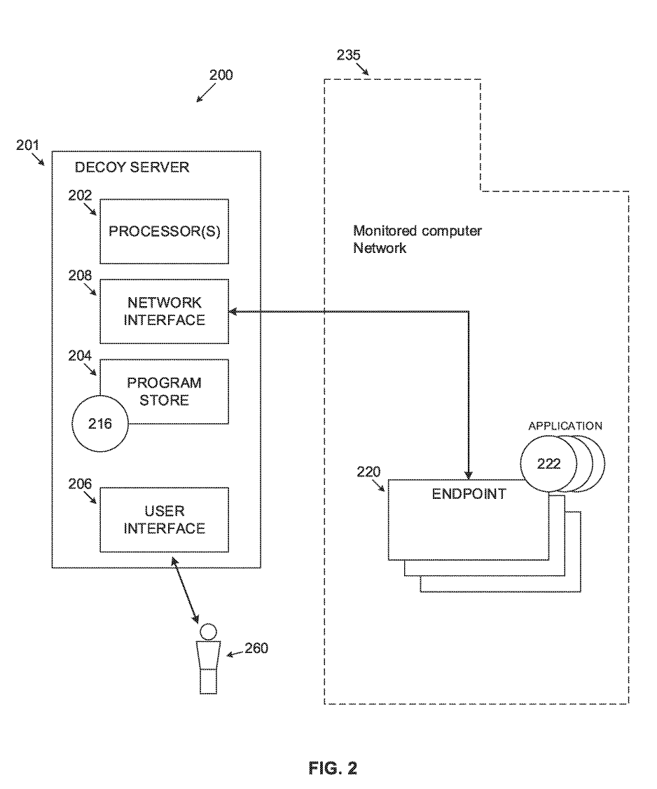

Reference is also made to FIG. 2 which is an exemplary embodiment of a system 201 and a monitored computer network 235 for creating and deploying threat specific deception campaigns in order to reduce false positive detection of malicious activities in the monitored computer network 235, according to some embodiments of the present invention.

The exemplary system 200 may be used to execute a process such as the process 100. The threat specific deception campaign(s) include creating, maintaining and monitoring the threat specific deception environment in one or more computing nodes 220 of the monitored computer network 235.

The system 200 is executed to dynamically deploy threat specific deception campaign(s) in a monitored computer network 235 that comprises the plurality of computing nodes 220 which are connected to the monitored computer network 235 which optionally to a network facilitated through the monitored computer network 235.

The network may be, for example, a local area network (LAN), a wide area network (WAN), a personal area network (PAN), a metropolitan area network (MAN) and/or the internet. The system 200 includes one or more processor 202 which execute a threat management software module 216 for scoring a malicious activity threat detected by monitoring processes executed on and/or by the plurality of endpoints 220 in the monitored computer network 235 and for determining how to react to the malicious activity threat, for instance whether to ignore, to deploy threat specific deception campaign(s), and/or to instruct alerting an operator such as a security analyst and/or a security handling software module (not shown) that launches defensive processing actions (i.e. reactions) in response to a detection of a threat, for instance process blocking actions, memory access control actions, process and/or file deletions, process and/or file data backup actions, and/or the like.

The monitored computer network 235 may be a local monitored computer network that may be a centralized single location network where all the endpoints 220 are on premises or a distributed network where the endpoints 220 may be located at multiple physical and/or geographical locations. The monitored computer network 235 may further be a virtual monitored computer network hosted by one or more cloud services 245, for example, Amazon Web Service (AWS), Google Cloud, Microsoft Azure and/or the like. The monitored computer network 235 may also be a combination of the local monitored computer network and the virtual monitored computer network.

The monitored computer network 235 may be, for example, an organization network, an institution network and/or the like. The endpoint 220 may be a physical device, for example, a computer, a workstation, a server, a processing node, a cluster of processing nodes, a network node, a Smartphone, a tablet, a modem, a hub, a bridge, a switch, a router, a printer and/or any network connected device having one or more processors. The endpoint 220 may further be a virtual device hosted by one or more of the physical devices, instantiated through one or more of the cloud services and/or provided as a service through one or more hosted services available by the cloud service(s). Each of the endpoints 220 is capable of executing one or more real applications 222, for example, an OS, an application, a service, a utility, a tool, a process, an agent and/or the like and/or deception applications as described below. The endpoint 220 may further be a virtual device, for example, a virtual machine (VM) executed by the physical device. The virtual device may provide an abstracted and platform-dependent and/or independent program execution environment. The virtual device may imitate operation of the dedicated hardware components, operate in a physical system environment and/or operate in a virtualized system environment. The virtual devices may serve as a platform for executing one or more of the real applications 222 utilized as system VMs, process VMs, application VMs and/or other virtualized implementations.

The threat management software module 216 may be executed on a server 201, for example, a computer, a workstation, a server, a processing node, a cluster of processing nodes, a network node and/or the like. The server 201 comprises a processor(s) 202, a program store 204 for storing the threat management software module 216, and optionally a user interface 206 for interacting with one or more users 260, for example, an information technology (IT) person, a system administrator and/or the like and a network interface 208 for communicating with computing nodes 220 of the network 235. The processor(s) 202, homogenous or heterogeneous, may include one or more processing nodes arranged for parallel processing, as clusters and/or as one or more multi core processor(s). The user interface 206 may include one or more human-machine interfaces, for example, a text interface, a pointing devices interface, a display, a touchscreen, an audio interface and/or the like. The program store 204 may include one or more non-transitory persistent storage devices, for example, a hard drive, a Flash array and/or the like. The program store 204 may further comprise one or more network storage devices, for example, a storage server, a network accessible storage (NAS), a network drive, and/or the like. The program store 204 may be used for storing one or more software modules each comprising a plurality of program instructions that may be executed by the processor(s) 202 from the program store 204.

Reference is made once again to FIG. 1. The process 100 may be executed using the threat management software module 216. First, as shown at 101, an analysis of a plurality of processes executed by the plurality of computing nodes 220 of the monitored computer network 235, also referred to as a monitored computer network, is held. The monitoring may be performed as general deception campaigns, for example as described in U.S. patent application Ser. No. 15/414,850 which is incorporated herein by reference or by PCT Application No. PCT/IB2016/054306 titled “Decoy and Deceptive Data Object Technology” which is incorporated herein by reference. For example, monitored processes are threads or events monitored at the kernel and/or OS level at some or all of the computing nodes 220 as described above. The analysis is optionally performed centrally by the threat management software module 216 and/or by distributed threat evolution software modules which are installed in some or all of the computing nodes 220. The processes may also be login events, resource access events, computer communication events, file copying events and/or the like. A malicious activity threat may be any process and/or filtered processes, for example processes which are not signed or recognized in a white list. A malicious activity threat may be detected using various methods such as analysis of processes using deep learning classification modules (e.g. trained neural networks), a rule based software module for classifying processes, expert system units for classifying processes or any other automated process classification procedure. The processes may be induced by malicious software activity or by human activity. The monitoring may be continuously held as depicted in 108.

Now, as shown at 102, an absence or a presence of a malicious activity threat is detected in potentially compromised computing node(s) of the computing nodes of the monitored computer network 235 based on an outcome of the analysis. The potentially compromised computing node(s) are one or more computing nodes selected from the computing nodes of the monitored computer network and used for executing processes according to which the malicious activity threat is identified. For example, the compromised computing node(s) are devices on which suspected login activity or file access activity or usage is detected and/or on which suspected computer communication is held (e.g. detecting login from an unexpected location).

As shown at 103, when the malicious activity threat is identified, a score is set thereto according to one or more potential damage characteristics of the malicious activity threat and/or of the potentially compromised computing node(s). The potential damage characteristics may be extracted from a threat characteristics dataset summarizing potential damage characteristics per thread and/or per computing node in the network 235. The potential damage characteristics may be an urgency to handle value, severity value, and certainty value. The potential damage characteristics may be manually inputted and/or learnt. A potential damage characteristic may be a network location of the computing node used for executing processes related to the malicious activity threat in the monitored computer network 235 and/or a location from which the computing node is accessed. A potential damage characteristic may be a type of the computing node used for executing processes related to the malicious activity threat. A potential damage characteristic may be level of credentials used to access the computing node used for executing processes related to the malicious activity threat and/or the right of access given to these credentials. A potential damage characteristic may be a level of sensitivity given to data stored in or accessible by the computing node used for executing processes related to the malicious activity threat. The processes may be induced by malicious software activity or by human activity.

The score may comprise a number of sub scores such as an urgency sub score, a severity sub score, and a certainty sub score. In such embodiments, the threshold may be cumulative and/or comprise a plurality of sub thresholds which are used for judging each one of the sub scores separately. For brevity, sub threshold may be referred to herein as a threshold.

The urgency sub score is based on an urgency to handle value indicative of a time frame for providing a response to the identified threat, for instance taken from the threat characteristics dataset. Optionally, the urgency sub score is dynamically updated to reflect the timeframe left for handling the threat. For example, a threat is time stamped when detected and a potential damage characteristic of the threat which is indicative of a timeframe to handle is used for calculating the current sub score (based on the time stamp). The time stamping may be event based, for example provided when a process goes through a certain event such as reading a record, writing a record, using certain files and/or reaching a certain size. When no time is left the sub score is maximized to trigger immediate investigation, for instance by triggering alerting an operator (e.g. by sending a message such as an email or an SMS or in system message) and/or by triggering defensive processing actions (i.e. reactions). The urgency sub score may be determined based on the type of the process, for instance a type indicated as a potential damage characteristic in the above dataset. When there is time, the given urgency sub score is low for facilitating the deployment of a threat specific deception campaign for acquiring additional data for avoiding false positive classification of the potential threat. The urgency sub score may be determined based on characteristics of the potentially compromised computing node(s), for example which credentials are given to the used account, which data is stored or accessible via the potentially compromised computing node(s) and/or the like.

Optionally, the urgency sub score is given based on a stage in an estimated attack path. The stage in the estimated attack path may be determined by matching a network location, a location from which the computing node is accessed, a type of computing node, event(s) related to the classified process and/or the like with a network location reference, a type of computing node reference, event(s) related to the classified process reference and/or any other reference given to identify a stage in an estimated attack path template accessible to the threat management software module. As used herein an attack path is an order set of computing nodes (e.g. network resources such as routers, servers, and storage devices and/or endpoints) and/or actions taken during a malicious activity to get to sensitive information or data such as financial credential and/or information, personal credential and/or information, trade secrets, passwords, and/or the like. A location in an attach path is important as the more advance is an intruder on an attack path the closer he is to sensitive information.

The severity sub score may be determined based on a stage in an estimated attack path, for instance as described above and/or based on any of the above potential damage characteristics. Similarly, certainty sub score may be determined based on a stage in an estimated attack path, for instance as described above and/or based on any of the above potential damage characteristics.

As shown at 104-106 a number of actions may be performed based on the calculated score. As shown at 104, when the score is below a first threshold, no action is taken. Alternatively or additionally, when a threat specific deception campaign, launched as depicted in 106, does not yield scoring the threat with a score that is above the second score, the specific deception campaign is cancelled, for example as described below.

As shown at 105, when the score is above a second threshold, an operator is notified and/or active reaction action(s) are taken. The defensive processing action(s) (i.e. reaction action(s)) may be blocking, filtering, deleting, and/or withholding processes and/or files of malicious software associated with the threat. Additionally or alternatively, the defensive processing action(s) may be backing up, duplicating, deleting, and/or encrypting processes and/or files threatened by the malicious software. Additionally or alternatively, the defensive processing action(s) may be blocking, filtering, deleting, and/or withholding communication between computing nodes of the monitored computer network 235.

As shown at 106, when the score is above the first threshold and below the second threshold, a threat specific deception campaign is launched (clearly when negative scores are given threat specific deception campaign is launched when the score is above the second threshold and below the first threshold). Launching a threat specific deception campaign involves using one or more deception application(s) executed by the computing node on which the process(es) identified with the malicious activity threat for gathering additional data and updating the score according to an analysis of the additional data. The threat specific deception campaign optionally involves deploying the deception application(s) when the score is above the first threshold and below the second threshold. The deployment may be as described in U.S. patent application Ser. No. 15/414,850 which is incorporated herein by reference or by PCT Application No. PCT/IB2016/054306 titled “Decoy and Deceptive Data Object Technology” which is incorporated herein by reference. The deception application(s) may be adapted to monitor a specific activity estimated to be executed on the potentially compromised computing node(s).

The threat specific deception campaign may be generated based on a specific deception campaign template selected from a dataset of campaign templates, for instance by matching between parameters of the campaign templates and potential damage characteristics of the malicious activity thread or any other identifier of the malicious activity thread. Each specific deception campaign template optionally includes references to of copies of matching deception application(s) and/matching deception objects and optionally deployment instructions. The threat specific deception campaign may be deployment instructions automatically calculated based on potential damage characteristics of the malicious activity thread or any other identifier of the malicious activity thread, for instance based on a set of rules and/or a finite state machine and/or a mathematical model.

Optionally, the deception application and/or the deception objects are selected according to characteristics of the potentially compromised computing node(s) node, for example to match the operating system of the potentially compromised computing node(s), the emulate files commonly used by the potentially compromised computing node(s) by duplicating at least some of its existing content, by adding decoy links or cookies which are selected according to browsing activity detected in potentially compromised computing node(s), for instance by an analysis of browsing activity and/or cookies and/or the like. For example, the threat specific deception campaign may be held by deploying a decoy cookie emulating an access to a resource historically accessed by the potentially compromised computing node(s) for facilitating a detection of an access to the decoy cookie.

Optionally, the deception application and/or the deception objects are selected according to an analysis of log(s) comprising historical execution activity of applications on the potentially compromised computing node(s), for example identifying which application and creating decoy files which are appeared to create by these applications, for instance having suitable file extensions and/or file size.

Optionally, the deception application and/or the deception objects are selected according to an analysis of network resource access actions held by the potentially compromised computing node(s). The network resource access actions may be access to storage and shared resources via the monitored computer network 235.

Optionally, the deception application and/or the deception objects are selected according to an analysis of a log documenting communication between the potentially compromised computing node(s) and additional computing nodes from the computing nodes 220. In use, emails or other messages maybe analyzed to detect addressees and computing devices associated with these addressees maybe used for deploying deception application and/or the deception objects. This allows gathering further additional data and updating the score according to an analysis of this further additional data. In another example, the documented communication is of devices accessed from the potentially compromised computing node(s). This allows deploying the deception application and/or the deception objects in computing node(s) which may be used in an attack path.

Optionally, the deception application and/or the deception objects are selected according to a type of a common use in the potentially compromised computing node(s). For example, when the potentially compromised computing node(s) are used for programming, code files may be used as decoy files and if the potentially compromised computing node(s) are used for bookkeeping, Excel™ files maybe used as decoy files.

By launching the threat specific deception campaign more information about the malicious activity is gathered, for instance whether any of a plurality of deception data objects are accessed. As shown at 107, launching the threat specific deception campaign allows rescoring the threat and to avoid false notification of an operator and/or unneeded triggering of active reaction action(s). Optionally, launching the threat specific deception campaign includes deploying plurality of deception data objects which are selected according to the potential damage characteristics of the malicious activity threat. The deception data objects are optionally deployed in the computing node on which the process(es) identified with the malicious activity threat for gathering additional data are found. The deception data objects are optionally as described above and/or in U.S. patent application Ser. No. 15/414,850 which is incorporated herein by reference or by PCT Application No. PCT/IB2016/054306 titled “Decoy and Deceptive Data Object Technology” which is incorporated herein by reference.

As outlined above, the threat specific deception campaign is used for increasing the reliability of the score given to the malicious activity threat by gathering more data indicative of a malicious activity or lack of such a malicious activity. When data indicative that the malicious activity is gathered, the score is updated and defensive processing action(s) are triggered and/or the operator is alarmed. Else, no action is taken to avoid false positive detection that involves wasting computing resources and/or manpower time and/or giving false information. Optionally, a Bayesian method to evaluate the additional data gathered using the threat specific deception campaign.

Optionally, when the malicious activity threat is identified as having an attack path that involves a number of exposed computing nodes of the monitored computer network 235. In such embodiments, the threat specific deception campaign may involve deploying plurality of deception applications and/or plurality of deception data objects in some or all of the exposed computing nodes of the monitored computer network 235. For instance exposed computing nodes are computing nodes which are accessible using credentials which are estimated to be in the possession of the attacker based on the network location of the computing node at which a respective process has been identified and/or a location from which the computing node is accessed. Optionally, the exposed computing nodes are selected according to an attack path matched with the malicious activity threat, for instance as described above. It is possible that the deception campaign deployed will not be on the computing node at which a respective process has been identified but along the path of attack projected by collected information. One reason is that such a distribution of plurality of deception applications and/or plurality of deception data objects is very hard for an attacker to identify.

It should be noted that the above described embodiments are described in the context of a threat analysis system for a monitored computer network 235 such as an organizational network. However, the above methodology may be used for a web application firewall that instead of automatically reporting about a threat to an application diverts possible attack processes to a copy of the application in a sandbox or in another restricted environment that contains no or limited important information. When a likelihood of the score of the observed process passes a threshold the attack is reported and/or defensive processing actions are launched. In such a manner false positive classification of attacks is avoided while risk is not increased.

In other embodiments, the above methodology is employed in any context in which security not only monitored but deployed directly or by communication with other security products and deception elements. This could also be about studying threats or collecting malicious activity patterns to block.

Reference is now made to a number of possible examples of executing the method depicted in FIG. 1 using the system depicted in FIG. 2. In a first example, a network is monitored for possible attacks. It is discovered that a computing node associated with Alice has an unusual login with unusual credentials and/or at a suspected time. From the time of the login and the device a network location it is assumed with 50% certainty (certainty sub score) that it was not Alice and may be an intruder. Alice is a graphical designer working as a contractor for the company and not privy to confidential information however she has an account on a computer in which other store confidential information. While the severity sub score is high the urgency sub score is low as the attacker has a lot of work ahead of him getting into network resources with sensitive information. The result of the threat score is to create a deception campaign centered on Alice's account and the related computing devices. For instance objects such as fake accounts are added to the computing devices which are related to Alice, logs are update to show fake logging, files containing decoy sensitive information are added in storage locations which are not likely to accessed by Alice, for instance folder not frequently accessed by Alice and/or file named with names not used by Alice in the past. Other deception objects maybe added based on the fact that Alice is not a programmer or a researcher and there are actions she is not likely to take are added. When a deception object is triggered than an operator is informed and/or defensive processing actions are launched; however, when no deception object is triggered the threat score is downgraded and no further action is taken. After a while the deployed objects and application may be automatically deleted.

In another example, there is a suspected break into an account of a user named Bob. This account is associated with a single computing node so it will be hard to use this computing node to break into the organization; however, As Bob account has sensitive information of the company on his device, the urgency sub score is high as the attacker, if there is one, already got an access to a computing device that allows his to install a payload. As used herein, a payload may be a component that executes a malicious activity. When the urgency sub score is so high an operator is immediately informed and/or defensive processing actions are immediately launched. Automatic security like turning off the account may be taken.

In another example, there is a suspected break into an account of a user named Carol. The account is used to connect a laptop to an office computer via a virtual private network (VPN) and/or a remote desktop connection such as Citrix™ while Carol is out of the office. In this example, the process a malware infected software installed when the laptop was used for private browsing. This is detected by an agent executed on the laptop and at the next possible time appropriate breadcrumbs are automatically installed on her machine (e.g. additional VPN connection and credentials), cookies to decoy internal company website, etc.). As soon as the system detects e.g. access to the decoy internal website the threat score for her machine is increased and an operator is immediately informed and/or defensive processing actions are immediately launched.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term a processor, a computing node is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for deploying threat specific deception campaigns for updating a score given to a malicious activity threat comprising:
performing an analysis of a plurality of processes executed by a plurality of computing nodes of a monitored computer network; and
when an outcome of said analysis is indicative of a malicious activity threat to said monitored computer network from at least one process of said plurality of processes which is executed on at least one computing node of said plurality of computing nodes:
setting a score to said malicious activity threat according to at least one potential damage characteristic of said malicious activity threat;
when said score is above a first threshold launch a threat specific deception campaign by using at least one deception application executed by said at least one computing node for gathering additional data and updating said score according to an analysis of said additional data, and
when said score or said updated score is above a second threshold generate instructions for at least one of alerting an operator and reacting to said malicious activity threat by performing at least one defensive processing action.

2. The method of claim 1, wherein said at least one potential damage characteristic comprises a network location of said at least one computing node in said monitored computer network.

3. The method of claim 1, wherein said at least one potential damage characteristic comprises a location from which said at least one computing node is being accessed when said at least one process in performed.

4. The method of claim 1, wherein said at least one potential damage characteristic comprises an estimated level of certainty of an actualization of said malicious activity threat.

5. The method of claim 1, wherein said threat specific deception campaign is held by:
selecting a plurality of deception data objects according to a malicious activity threat;
deploying said plurality of deception data objects in said at least one computing node;
detecting usage of information contained in at least one of said plurality of deception data objects; and
wherein said additional data is indicative of said usage of information.

6. The method of claim 1, wherein said at least one deception application is selected according to at least one computing node characteristic of said at least one computing node.

7. The method of claim 1, wherein said at least one deception application is selected according an analysis of a log comprising historical execution activity of a plurality of applications on said at least one computing node.

8. The method of claim 1, wherein said at least one deception application is selected according an analysis of resource access action held by said at least one computing node.

9. The method of claim 1, wherein said at least one deception application is selected according an analysis of a log documenting communication between said at least one computing node and at least one additional computing node from said plurality of computing nodes; wherein said threat specific deception campaign is held by
using at least one additional deception application executed by said at least one additional computing node for gathering further additional data and updating said score according to an analysis of said further additional data.

10. The method of claim 1, wherein said threat specific deception campaign is held by:
identifying a type of a common use in said at least one computing node by at least one user and deploying at least one deception data object according to said common use.

11. The method of claim 10, wherein said type of a common use is selected from a group consisting of: software development usage, word processing usage, and a network storage usage.

12. The method of claim 1, wherein said threat specific deception campaign is held by deploying a decoy cookie emulating an access to a resource historically accessed by said at least one computing node and detecting an access to said decoy cookie; wherein said additional data is indicative of said access.

13. The method of claim 1, wherein said threat specific deception campaign is held by deploying a decoy file similar to a file historically accessed by said at least one computing node and detecting an access to said decoy file; wherein said additional data is indicative of said access.

14. The method of claim 1, wherein said setting comprises setting a plurality of sub scores defining a certainty value for said malicious activity threat to occur and a severity of damage from said malicious activity threat when occurred; wherein said first threshold comprises a certainty sub threshold and a severity sub threshold; said score is above said first threshold when said certainty value is above said certainty sub threshold and said severity value is above said severity sub threshold.

15. A non transitory computer readable medium comprising computer executable instructions adapted to perform the method of claim 1.

16. A system for deploying threat specific deception campaigns for updating a score given to a malicious activity threat, comprising:
at least one processor adapted to execute a code stored in a program store for:
performing an analysis of a plurality of processes executed by a plurality of computing nodes of a monitored computer network; and
when an outcome of said analysis is indicative of a malicious activity threat to said monitored computer network from at least one process of said plurality of processes which is executed on at least one computing node of said plurality of computing nodes:
setting a score to said malicious activity threat according to at least one potential damage characteristic of said malicious activity threat;
when said score is above a first threshold launch a threat specific deception campaign by using at least one deception application executed by said at least one computing node for gathering additional data and updating said score according to an analysis of said additional data, and
when said score or said updated score is above a second threshold generate instructions for at least one of alerting an operator and reacting to said malicious activity threat by performing at least one defensive processing action.
